(19) United States
(12) Patent Application Publication
(10) Pub. No.: US 2025/0293750 A1
(43) Pub. Date: Sep. 18, 2025

(54) CHANNEL AND INTERFERENCE MEASUREMENT

(71) Applicant: ZTE Corporation, Shenzhen (CN)

(72) Inventors: Xingguang WEI, Shenzhen (CN); Jian LI, Shenzhen (CN); Xianghui HAN, Shenzhen (CN); Xing LIU, Shenzhen (CN); Shuai FENG, Shenzhen (CN)

(73) Assignee: ZTE Corporation, Shenzhen (CN)

(21) Appl. No.: 19/222,488

(22) Filed: May 29, 2025

Related U.S. Application Data
(63) Continuation of application No. PCT/CN2023/074856, filed on Feb. 7, 2023.

(51) Int. Cl. H04B 7/06; H04W 24/10

(52) U.S. Cl. CPC H04B 7/0639; H04W 24/10

(57) ABSTRACT

New mechanisms for channel measurement and interference measurement between an aggressor and victim wireless includes transmitting a set of Reference Signals (RS) to a victim wireless device including M RS resources, wherein M is an integer larger than 1, and wherein an i^{th} individual RS resource of the M RS resources includes Pᵢ RS ports, wherein i is an integer and 1≤i≤M, and wherein Pᵢ is an integer and Pᵢ≥1. The method may include receiving a measurement report regarding the RS including a Precoding Matrix Indicator (PMI) report and a phase offset report. In another embodiment, a method includes indicating a RS configuration and a Cross Link Interference (CLI) measurement resource configuration, wherein each RS includes an aggressor ID, and wherein the CLI measurement resource configuration associates each one of the RS with CLI measurement resources. The method may also include transmitting the RS according to the RS configuration.

### TECHNICAL FIELD

This disclosure generally relates to channel and interference measurement, and more specifically to a flexible channel and interference measurement mechanism that can accommodate different numbers of antenna ports.

### BACKGROUND

In a cellular network, measurements of the CLI (Cross Link Interference) between UEs (User Equipment) typically occur such that a victim UE (the UE subject to interference) can measure the Sounding Reference Signal (SRS) transmitted by the aggressor UE (the UE causing the interference) and report the Reference Signal Receiving Power (RSRP) or the Received Signal Strength Indicator (RSSI). In a dynamic TDD network, where different base stations apply different TDD slot format configurations or apply different Sub-Band Full Duplex (SBFD) configurations, channel measurement result and interference measurement result between an aggressor base station and a victim base station are important for CLI handling. Meanwhile, channel measurement result and interference measurement result between an aggressor UE and a victim UE are important for CLI handling, especially for SBFD systems.

The CSI-RS (Channel State Information—Reference Signal) has been defined in existing New Radio (NR) specifications for channel measurement between a gNB (e.g., base station) and a UE. However, currently, CSI-RS only supports maximum 32 ports, which means CSI-RS can only be used to measure up to 32 antenna ports. If the antenna ports on the Tx (Transmitter) side or Rx (Receiver) side exceeds 32 ports, the existing CSI-RS cannot be applied in this case. With the increase number of Tx antenna ports and Rx antenna ports, it is impossible to define reference signals with such a large number of ports to accommodate different network deployments.

In addition, reference signals for channel measurement and reference signals for interference measurement are separately configured. The victim can identify the aggressor ID (identity) via channel measurement. The victim can measure the interference strength via interference measurement. Without association between reference signals for channel measurement and reference signals for interference measurement, the base station and UE cannot make the best use of the measurement information.

### SUMMARY

This disclosure generally relates to channel and interference measurement, and more specifically to new mechanisms for channel measurement and interference measurement between the aggressor and victim to accommodate different numbers of antenna ports. As a part of this improved measurement mechanism, measurement reports are issued which include a Precoding Matrix Indicator (PMI) report and a phase offset report. By providing the phase offset report, a combined precoding matrix can be accurately created when multiple precoding matrixes are provided. By allowing for multiple precoding matrixes, greater flexibility is provided for channel and interference measurement, for example, by allowing for more than 32 ports.

In another embodiment, a mechanism for association between reference signals for channel measurement and reference signals for interference measurement are proposed. Reference Signals (RS) include an aggressor ID and are associated with one or more Cross Link Interference (CLI) measurement resources. As such, upon identifying an aggressor, a victim can measure only the CLI measurement resources that are associated with the RS corresponding to the identified aggressor. In this manner, the measurement efficiency for the victim can be increased, and both of channel state and CLI strength can be obtained by the victim.

In some exemplary implementations, a method performed by an aggressor wireless device for channel and interference measurement is disclosed. The method may include transmitting a set of Reference Signals (RS) to a victim wireless device. Similarly, a method performed by a victim wireless device for channel and interference measurement is also disclosed, which may include receiving the set of Reference Signals (RS) from the aggressor wireless device. In various examples, the set of RS comprises M RS resources, wherein M is an integer larger than 1, and wherein an i^{th} individual RS resource of the M RS resources includes Pᵢ RS ports, wherein i is an integer and 1≤i≤M, and wherein Pᵢ is an integer and Pᵢ≥1. The method may include the victim wireless device generating a measurement report regarding the set of RS, the measurement report comprising a Precoding Matrix Indicator (PMI) report and a phase offset report, and transmitting the measurement report to the aggressor wireless device. The aggressor wireless device may receive, from the victim wireless device, the measurement report.

In some exemplary implementations, which may be combined with any of the other exemplary implementations disclosed herein, the method also includes deriving, by the aggressor wireless device, a combined precoding matrix using the PMI report and the phase offset report.

In some exemplary implementations, which may be combined with any of the other exemplary implementations disclosed herein, M groups of RS resources are configured to the victim wireless device, where each group contains Kᵢ RS resources, wherein Kᵢ is an integer greater than 1, and wherein an i^{th} RS resource is from an i^{th} group of the M groups of RS resources.

In some exemplary implementations, which may be combined with any of the other exemplary implementations disclosed herein, the method also includes the victim wireless device generating the PMI report to include M PMIs each corresponding to one of the M RS resources, wherein each PMI of the M PMIs corresponds to one precoding matrix. The method may also include the victim wireless device generating the phase offset report to include M−1 phase offsets, and measuring an m^{th} phase offset as a phase offset of an (m+1)^{th} precoding matrix compared with a first precoding matrix, where m is an integer and 1≤m≤M−1. In various implementations, the measurement report is a subband report, the M PMIs are for each subband, and the M−1 phase offsets are for each subband.

In some exemplary implementations, which may be combined with any of the other exemplary implementations disclosed herein, the method also includes the victim wireless device generating the PMI report to include X PMIs corresponding to the M RS resources, wherein X=M·N, wherein N is an integer larger than 0, a first set of N PMIs of the X PMIs correspond to a first RS resource of the M RS resources, an M^{th} set of N PMIs of the X PMIs correspond to an M^{th} RS resource of the M RS resources, and each PMI of the X PMIs corresponds to one precoding matrix. The method may also include the victim wireless device generating the phase offset report to include X−1 phase offsets, and measuring an m^{th} phase offset as a phase offset of an (m+1)^{th} precoding matrix compared with a first precoding matrix, where m is an integer and 1≤m≤X−1. In various implementations, the measurement report is a subband report, the X PMIs are for each subband, and the X−1 phase offsets are for each subband.

In some exemplary implementations, which may be combined with any of the other exemplary implementations disclosed herein, the phase offset report comprises a plurality of phase offsets, and each phase offset of the plurality of phase offsets may be indicated by a phase offset sign (o) and a phase offset value (p). The phase offset sign (o) may be indicated by one bit. The phase offset value (p) may be indicated by an index k, wherein

$$p = \frac{k}{K} \cdot π ,$$

where K is an integer number larger than 1, and k is nonnegative integer number between 0 and K−1.

In some exemplary implementations, which may be combined with any of the other exemplary implementations disclosed herein, the method also includes the victim wireless device deriving a channel state matrix between the aggressor wireless device and the victim wireless device, wherein for an i^{th} RS resource of the M RS resources, the derived channel state matrix is H_{P}_{ᵢ}_{×Q}ⁱ, where Q is at least one of a number of RX ports of the victim wireless device or a rank number. The method may also include the victim wireless device deriving an i^{th} phase offset (P_{offset, i}) of a plurality of phase offsets of the phase offset report corresponding to an (i+1)^{th} precoding matrix compared with a first precoding matrix, wherein the i^{th} phase offset is derived as a phase offset between a value in the first row and first column of the (i+1)^{th} channel matrix and a value in a first row and first column of the first channel matrix. In various approaches, the phase offset is derived using the equation P_{offset,i}=tan⁻¹ H_{1×1}ⁱ⁺¹−tan⁻¹ H_{1×1}¹.

Similarly, the method may also include the victim wireless device deriving an i^{th} phase offset (P_{offset, i}) of a plurality of phase offsets of the phase offset report corresponding to an (i+1)^{th} precoding matrix compared with a first precoding matrix, wherein the i^{th} phase offset is derived as an average offset between each value in the (i+1)^{th} channel matrix and a corresponding value of the first channel matrix. In various approaches the phase offset is derived using the equation

$${P}_{o f f s e t , i} = \frac{{Σ}_{m = 1 , n = 1}^{m = M , n = Q} {tan}^{- 1} {H}_{m \times n}^{i + 1} - {tan}^{- 1} {H}_{m \times n}^{1}}{M \cdot Q} ,$$

where m and n are integer numbers.

In various embodiments, the aggressor wireless device and the victim wireless device include at least one of the following combinations: the aggressor wireless device and the victim wireless device are both wireless access network nodes; the aggressor wireless device and the victim wireless device are both wireless terminal devices; the aggressor wireless device is a wireless access network node and the victim wireless device is a wireless terminal device; or the aggressor wireless device is a wireless terminal device and the victim wireless device is a wireless access network node. In various approaches, each RS resource of the M RS resources is configured with a same number of RS ports. Also, in various embodiments, the aggressor wireless device may transmit, and the victim wireless device may receive the M RS resources in a same slot or in consecutive slots.

In some exemplary implementations, another method performed by an aggressor wireless device for channel and interference measurement is disclosed. The method may include indicating, to a victim wireless device, a Reference Signals (RS) configuration and a Cross Link Interference (CLI) measurement resource configuration. Similarly, a method performed by a victim wireless device for channel and interference measurement is also disclosed, which may include receiving the indication from the aggressor wireless device of the RS configuration and the CLI measurement resource configuration. In various examples, the RS configuration configures at least one RS, each RS of the at least one RS includes an aggressor ID of the aggressor wireless device, and the CLI measurement resource configuration associates each one of the at least one RS with M CLI measurement resources, wherein M is an integer greater than 0. The method may include the aggressor wireless device transmitting, and the victim wireless device receiving, the at least one RS according to the RS configuration.

In some exemplary implementations, which may be combined with any of the other exemplary implementations disclosed herein, the method also includes the victim wireless device measuring the M CLI measurement resources associated with the at least one RS to generate measurement results of the at least one RS or the M CLI measurement resources associated with the at least one RS, and transmitting the measurement results to the aggressor wireless device. The measurement results may include the aggressor ID of the aggressor wireless device, a Channel State Information (CSI) report based on the at least one RS, and/or a CLI strength report based on the M CLI measurement resources. The CLI strength report may further include at least one of the following: a Received Signal Strength Indicator (RSSI) for each of the M CLI measurement resources; an average RSSI among all the M CLI measurement resources; N CLI measurement resource indicators, wherein N is an integer greater than 0, and where the maximum N RSSI values are measured in the CLI measurement resources corresponding to the CLI measurement resource indicators; N CLI measurement resource indicators, wherein N is an integer greater than 0, where the minimum N RSSI values are measured in the CLI measurement resources corresponding to the CLI measurement resource indicators; or N CLI measurement resource indicators and corresponding RSSI, wherein N is an integer greater than 0, and wherein the N CLI measurement resource indicators correspond to N CLI measurement resources in which the maximum or minimum N RSSI values are measured.

In some exemplary implementations, which may be combined with any of the other exemplary implementations disclosed herein, the RS configuration may indicate occupied Resource Blocks (RBs) by the at least one RS, occupied symbols by the at least one RS, a periodicity and starting slot within the periodicity in time domain of occupied Resource Elements (RE) by the at least one RS, a transmission comb number indicating a gap between two REs occupied by the at least one RS in frequency domain, or a transmission comb offset indicating an offset for the REs occupied by the at least one RS.

In some exemplary implementations, which may be combined with any of the other exemplary implementations disclosed herein, the method also includes the aggressor wireless device transmitting, and the victim device receiving, the at least one RS in a last L symbols of a DL subband. Similarly, the method may include the aggressor device transmitting, and the victim device receiving, the at least one RS in a first L symbols of an UL subband. In various embodiments, each CLI measurement resource may be associated with P UL muting resources, where P is an integer larger than 0, wherein no uplink transmission is transmitted within each UL muting resource. In various approaches, each CLI measurement resource may be associated with Q DL muting resources, where Q is an integer larger than 0, wherein no downlink transmission is transmitted within each DL muting resource.

In some other implementations, an apparatus for wireless communication such as a network device is disclosed. The network device main include one or more processors and one or more memories, wherein the one or more processors are configured to read computer code from the one or more memories to implement any one of the methods above. The apparatus for wireless communication may be the wireless access node or the wireless terminal device.

In yet some other implementations, a computer program product is disclosed. The computer program product may include a non-transitory computer-readable medium with computer code stored thereupon, the computer code, when executed by one or more processors, causing the one or more processors to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows a wireless access network with an exemplary wireless communications in accordance with various embodiments.

FIG. 2 shows various example processing components of the wireless terminal device and the wireless access network node of FIG. 1.

FIG. 3 shows an example combined precoding matrix in accordance with various embodiments.

FIG. 4 shows an example slot formation and subband pattern in accordance with the new mechanisms disclosed in various embodiments herein.

FIG. 5 shows an example arrangement of resource elements and resource blocks in accordance with the new mechanisms disclosed in various embodiments herein.

FIG. 6 shows another example slot formation and subband pattern in accordance with the new mechanisms disclosed in various embodiments herein.

FIG. 7 shows an example of subbands including muting resources in accordance with the new mechanisms disclosed in various embodiments herein.

### DETAILED DESCRIPTION

The technology and examples of implementations and/or embodiments described in this disclosure can be used to facilitate channel and interference measurement in wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

Disclosed herein are new mechanisms for channel measurement and interference measurement between an aggressor wireless device (a wireless device causing interference) and a victim wireless device (a wireless device subject to that interference) to accommodate different numbers of antenna ports. As a part of this improved measurement mechanism, measurement reports are issued which include a Precoding Matrix Indicator (PMI) report and a phase offset report. By providing the phase offset report, a combined precoding matrix can be accurately created when multiple precoding matrixes are provided. By allowing for multiple precoding matrixes, greater flexibility is provided for channel and interference measurement, for example, by allowing for more than 32 ports.

In another embodiment, a mechanism for association between reference signals for channel measurement and reference signals for interference measurement are proposed. Reference Signals (RS) include an aggressor ID and are associated with one or more Cross Link Interference (CLI) measurement resources. As such, upon identifying an aggressor, a victim can measure only the CLI measurement resources that are associated with the RS corresponding to the identified aggressor. In this manner, the measurement efficiency for the victim can be increased, and both of channel state and CLI strength can be obtained by the victim.

### Wireless Network Overview

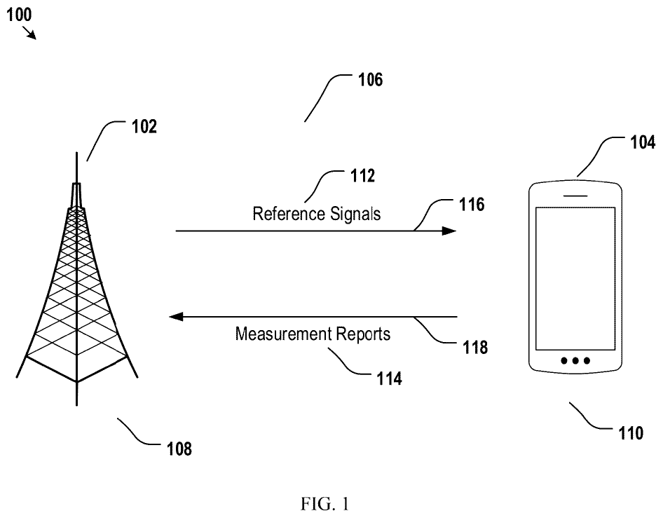

A wireless communication network may include a radio access network for providing network access to wireless terminal devices, and a core network for routing data between the access networks or between the wireless network and other types of data networks. In a wireless access network, radio resources are provided for allocation and used for transmitting data and control information. FIG. 1 shows an exemplary wireless access network 100 including a wireless access network node (WANN) or wireless base station 102 (herein referred to as wireless base station, base station, wireless access node, wireless access network node, or WANN) and a wireless terminal device or user equipment (UE) 104 (herein referred to as user equipment, UE, terminal device, or wireless terminal device) that communicates with one another via over-the-air (OTA) radio communication resources 106. The wireless access network 100 may be implemented as, as for example, a 2G, 3G, 4G/LTE, or 5G cellular radio access network. Correspondingly, the base station 102 may be implemented as a 2G base station, a 3G node B, an LTE eNB, or a 5G New Radio (NR) gNB. The user equipment 104 may be implemented as mobile or fixed communication devices installed with mobile identity modules for accessing the base station 102. The user equipment 104 may include but is not limited to mobile phones, laptop computers, tablets, personal digital assistants, wearable devices, distributed remote sensor devices, and desktop computers. Alternatively, the wireless access network 100 may be implemented as other types of radio access networks, such as Wi-Fi, Bluetooth, ZigBee, and WiMax networks.

In various embodiments of the present disclosure, as depicted in FIG. 1, the base station 102 may be an “aggressor” wireless device 108 (also simply referred to as the aggressor), and the UE 104 may be a “victim” wireless device 110 (also simply referred to as the victim). However, the present disclosure is not limited to such an arrangement. For example, the aggressor wireless device 108 and the victim wireless device 110 may both be base stations 102, the aggressor wireless device 108 and the victim wireless device 110 may both be UEs 104, the aggressor wireless device 108 may be a base station 102 and the victim wireless 110 device may be a UE 104, or the aggressor wireless device 108 may be a UE 104 and the victim wireless device 110 may be a base station 102. Reference is made throughout this disclosure and the claims to the “aggressor wireless device” 108 and the “victim wireless device” 110, and it is understood that each of those terms may represent either a base station 102 or a UE 104 in accordance with the above example arrangements.

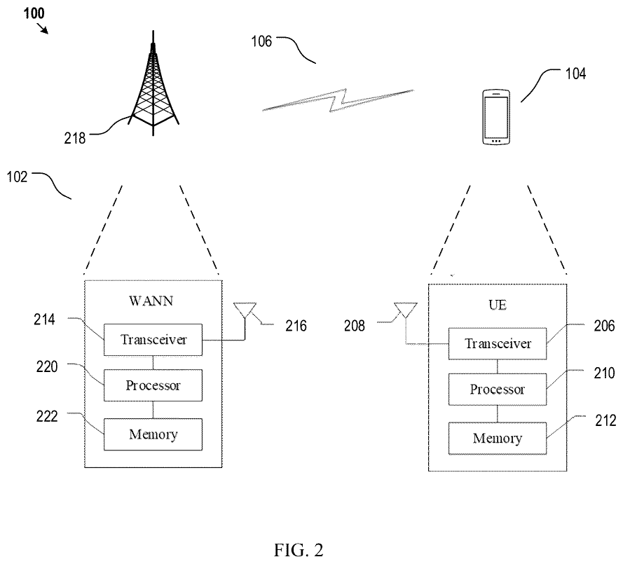

FIG. 2 further shows example processing components of the WANN 102 and the UE 104 of FIG. 1. The UE 104, for example, may include transceiver circuitry 206 coupled to one or more antennas 208 to effectuate wireless communication with the WANN 102 (or to other UEs). The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the, functions, methods, and processes described herein. Likewise, the WANN 102 may include transceiver circuitry 214 coupled to one or more antennas 216, which may include an antenna tower 218 in various forms, to effectuate wireless communications with the UE 104. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions, methods, and processes of the WANN 102 described herein.

### Reference Signals (RS)

In various embodiments, Reference Signals (RS) are signal that are used in the Downlink (DL) or Uplink (UL) channels for the purpose of measuring the characteristics of a radio channel so that the devices can adjust characteristics to optimize the channels (e.g., use correct modulation, code rate, beam forming etc.). For example, UEs 102 use the RS to measure the quality of the DL channel and send measurement reports in the UL channel, e.g., through Channel Quality Index (CQI) Reports. In various embodiments of the new mechanisms for channel measurement and interference measurement disclosed herein, the RS can be at least one of CSI-RS (Channel State Information Reference Signal), SRS (Sounding Reference Signal), synchronization signal including PSS (Primary Synchronization Signal) and SSS (Secondary Synchronization Signal), SSB (Synchronization Signal Block), or other types of RS.

In various embodiments of the new mechanisms for channel measurement and interference measurement disclosed herein, each RS resource may be associated with time domain information, frequency domain information, port information and other information such that the base station 102 or UE 104 can determine the corresponding time domain and frequency domain resource to transmit/receive RS, the corresponding power to transmit the RS, and/or the corresponding number of ports to transmit/receive RS. The time domain information may include starting symbol, slot index or periodicity etc. The frequency domain information may include the occupied RB/RE (Resource Block/Resource Element) index directly or implicitly. The port information may include the number of ports of this RS resource. Other information may include the power offset between this RS and other reference RS, e.g., synchronization signal.

Returning to FIG. 1, the radio communication resources for the over-the-air interface 106 may include a combination of frequency, time, and/or spatial communication resources organized into various resource units or elements in frequency, time, and/or space. The radio communication resources 106 in frequency domain may include portions of licensed radio frequency bands, portions of unlicensed ration frequency bands, or portions of a mix of both licensed and unlicensed radio frequency bands. The radio communication resources 106 available for carrying the wireless communication signals between the base station 102 and user equipment 104 may be further divided into physical downlink (DL) channels 116 for transmitting wireless signals from the base station 102 to the user equipment 104 and physical uplink (UL) channels 118 for transmitting wireless signals from the user equipment 104 to the base station 102.

As part of communication from the aggressor wireless device 108 to the victim wireless device 110 (e.g., the DL channels 116), the aggressor wireless device 108 may transmit Reference Signals (RS) 112. Similarly, in response, as part of communication from the victim wireless device 110 to the aggressor wireless device 108 (e.g., the UL channels 118), the victim wireless device 110 may transmit measurement reports 114. In accordance with the new mechanisms for channel measurement and interference measurement disclosed herein, the measurement reports 114 include a Precoding Matrix Indicator (PMI) report and a phase offset report.

### Description of New Channel Measurement and Interference Measurement Mechanisms

As mentioned above, in accordance with various embodiments, new mechanisms for channel measurement and interference measurement between an aggressor wireless device and a victim wireless device to accommodate different numbers of antenna ports. Measurement reports include a PMI report and a phase offset report, which allows for accurate creation of a combined precoding matrix when multiple precoding matrixes are provided. By allowing for multiple precoding matrixes, greater flexibility is provided for channel and interference measurement, for example, by allowing for more than 32 ports.

As mentioned above, in various approaches, the aggressor 108 and the victim 110 can be any one of the following combinations: the aggressor 108 and victim 110 are both base stations (e.g., base stations 102); the aggressor 108 and victim 110 are both UEs (e.g., UEs 104); the aggressor 108 and victim 110 are base station (e.g., base station 102) and UE (e.g., UE 104), respectively; or the aggressor 108 and the victim 110 are UE (e.g., UE 104) and base station (e.g., base station 102), respectively.

In accordance with various embodiments, a method performed by the aggressor wireless device 108, or by the victim wireless device 110, for channel and interference measurement is disclosed. As part of this method, the aggressor wireless device 108 transmits a set of Reference Signals (RS) 112 to the victim wireless device 110, and the victim wireless device 110 receives the set of RS from the aggressor wireless device 108. The set of RS includes M RS resources, wherein M is an integer larger than 1. Further, an i^{th} individual RS resource of the M RS resources includes Pᵢ RS ports, wherein i is an integer and 1≤i≤M, and wherein Pᵢ is an integer and Pᵢ≥1.

In accordance with various embodiments, the method also includes the victim wireless device 110 generating a measurement report regarding the set of RS, the measurement report comprising a Precoding Matrix Indicator (PMI) report and a phase offset report. The victim wireless device 110 then transmits the measurement report 114, including the PMI report and the phase offset report, to the aggressor wireless device 108, which is received by the aggressor wireless device 108.

In various embodiments, each RS resource of the M RS resources may be configured with the same number of RS ports. However, in some embodiments, different RS resources can be configured with a different number of RS ports. In some approaches, M groups of RS resources are configured to the victim wireless device 110, where each group contains Kᵢ RS resources, wherein Kᵢ is an integer greater than 1, and wherein an i^{th} RS resource is from an i^{th} group of the M groups of RS resources.

For example, base station A is equipped with 64 Tx ports and base station B is equipped with 4 Rx ports. In order to measure the channel state between base station A and base station B, CSI-RS is transmitted by base station A. Because the maximum number of CSI-RS port is 32 in the current NR specification, two CSI-RS resources are configured. Each CSI-RS is configured with 32 ports. In this example, M is equal to 2, where P₁ and P₂ are equal to 32, respectively. Two groups of RS resources are configured to base station B. For example, the first group includes CSI-RS #1, CSI-RS #2 and CSI-RS #3, and the second group includes CSI-RS #4 and CSI-RS #5. Base station A indicates CSI-RS #1 and CSI-RS #4 to base station B, where CSI-RS #1 and CSI-RS #4 are from the first group and the second group, respectively. In this example, K₁ and K₂ are 3 and 2, respectively.

In another example, base station A is equipped with 48 Tx ports and UE B is equipped with 4 Rx ports. In order to measure the channel state between the base station A and the UE B, base station A transmits CSI-RS to UE B. Two CSI-RS resources are configured. The first CSI-RS resource is may be configured with 32 ports and the second CSI-RS resource may be configured with 16 ports. In this example, M is equal to 2, P₁ and P₂ are equal to 32 and 16, respectively. Two groups of RS resources are configured to UE B. For example, the first group includes CSI-RS #1 and CSI-RS #2, the second group includes CSI-RS #3, CSI-RS #4 and CSI-RS #5. Base station A indicates CSI-RS #1 and CSI-RS #5 to UE B, where CSI-RS #1 and CSI-RS #5 are from the first group and the second group, respectively. In this example, K₁ and K₂ are 2 and 3, respectively. For example, the CSI-RS #1 may occupy the first four symbols in one slot and CSI-RS #5 may occupy the last two symbols in the same slot.

In various embodiments, the method may include the aggressor 108 transmitting (and the victim 110 receiving) the M RS resources in a same slot or in consecutive slots. Because the channel state changes dynamically and fast, the M RS resources should be transmitted close to each other such that the channel state changes as little as possible during the duration when these M RS resources are transmitted. For example, when the M RS resources are transmitted in the same slot, the M RS resources may be located on different time or frequency or space domain resources. When the M RS resources are transmitted in different slots, the M RS resources can be located on the same frequency and/or space domain resources.

The victim 110 receives the set of RS from the aggressor 108. The victim 110 then generates a measurement report and indicates or transmits the measurement report 114 to the aggressor 108. The measurement report 114 includes a PMI report and a phase offset report. The PMI is commonly used in existing communication systems to represent the channel state between a base station 102 and a UE 104. However, in accordance with various embodiments of the present disclosure, the PMI can be applied to represent the channel state between aggressor 108 and victim 110, either of which can be a base station 102 or a UE 104.

In certain embodiments, the victim 110 also indicates the number of Rx ports of itself to the aggressor 108. In some other embodiments, the victim 110 indicates a rank indicator to the aggressor 110.

In the case of a wideband report, the victim 110 may generate the PMI report so that it includes M PMIs each corresponding to one the M RS resources. For example, the first PMI among the PMI report may correspond to the first RS resource, the second PMI among the PMI report may correspond to the second RS resource, and so forth. Each PMI may correspond to one precoding matrix. For example, the first PMI among the PMI report may correspond to the first precoding matrix, the second PMI among the PMI report may correspond to the second precoding matrix, and so forth.

In case of wideband report, the victim 110 may generate the phase offset report to include M−1 phase offsets. For example, the first phase offset may correspond to the phase offset of the second precoding matrix compared with the first precoding matrix, the second phase offsets may correspond to the phase offset of the third precoding matrix compared with the first precoding matrix, and so forth. Put another way, the victim 110 may measure an mi phase offset as a phase offset of an (m+1)^{th} precoding matrix compared with a first precoding matrix, where m is an integer and 1≤m≤M−1.

The victim 110 may indicate or transmit the measurement report 114 to the aggressor 108. In various embodiments, the aggressor 108 derives a combined precoding matrix based on the measurement report 114, specifically, using the PMI report and the phase offset report. The aggressor 108 may also derive the channel between the aggressor 108 and the victim 110 based on the combined precoding matrix (and possibly other information, such as, for example, the parameter Q, described next).

In certain examples, the victim 110 is equipped with Q Rx ports or the victim 110 may indicate a rank number as Q to the aggressor 108. Assuming the precoding matrix reported by the victim 110 corresponding to the i^{th} PMI is W_{P}_{ᵢ}_{×Q}ⁱ, and the phase offset for the i^{th} PMI is P_{offset,i-1}, the combined precoding matrix is as follows:

$$W = [ \begin{matrix}{W}_{{P}_{1} \times Q}^{1} \\ {W}_{{P}_{2} \times Q}^{2} \cdot {e}^{j \cdot {P}_{offset , 1}} \\ ⋮ \\ {W}_{{P}_{i} \times Q}^{i} \cdot {e}^{j \cdot {P}_{offset , 1}} \\ ⋮ \\ {W}_{{P}_{M} \times Q}^{M} \cdot {e}^{j \cdot {P}_{offset , M - 1}}\end{matrix} ] ,$$

where i is an integer number and 1≤i≤M. P_{offset,1} is the phase offset corresponding to the second precoding matrix, P_{offset,2} is the phase offset corresponding to the third precoding matrix, and so forth. W_{P}_{ᵢ}_{×Q}ⁱ is a matrix with Pᵢ rows and Q columns, and j is the imaginary unit, i.e., j²=−1.

In other approaches, the measurement report is a subband report. In the case of a subband report, the PMI report includes M PMIs corresponding to the M RS resources for each subband, and the phase offset report includes M−1 phase offsets for each subband.

In some embodiments, in case of wideband report, the victim 110 may generate the PMI report to include X=M·N PMIs corresponding to the M RS resources, where N is an integer larger than 0, and, for example,

$$N = \frac{X}{M} .$$

In various examples, the first set of N PMIs among the X PMIs of the PMI report correspond td the first RS resource, the second set of N PMIs among the X PMIs of the PMI report correspond to the second RS resource, and so forth, and an M^{th} set of N PMIs of the X PMIs of the PMI report correspond to an M^{th} RS resource of the M RS resources. Each PMI of the X PMIs may correspond to one precoding matrix. For example, the first PMI among the PMI report may correspond to the first precoding matrix, the second PMI among the PMI report may correspond to the second precoding matrix, and so forth. N may be set differently dependent on, e.g., how many receiver ports the victim has, or a rank number, for example.

In case of wideband report, the victim 110 may generate the phase offset report to include (M·N)−1 phase offsets (e.g., X−1 phase offsets). In various embodiments, the first phase offset may correspond to the phase offset of the second precoding matrix compared with the first precoding matrix, the second phase offset may correspond to the phase offset of the third precoding matrix compared with the first precoding matrix, and so forth. Put another way, the victim 110 may measure an m^{th} phase offset as a phase offset of an (m+1)^{th} precoding matrix compared with a first precoding matrix, where m is an integer and 1≤m≤M−1.

In other approaches, the measurement report is a subband report. In case of subband report, the PMI report includes M·N PMIs (i.e., X PMIs) corresponding to the M RS resources for each subband, and the phase offset report includes M·N−1 phase offsets (i.e., X−1 phase offsets) for each subband.

As discussed above, the victim 110 may indicate or transmit the measurement report 114 to the aggressor 108. In various embodiments, the aggressor 108 derives a combined precoding matrix based on the measurement report 114, specifically, using the PMI report and the phase offset report. The aggressor 108 may also derive the channel between the aggressor 108 and the victim 110 based on the combined precoding matrix (and possibly other information, such as, for example, the parameter Q).

In certain examples, the victim 110 is equipped with Q Rx ports or the victim 110 indicates rank number as Q to the aggressor 108. Q is an integral multiple of N. Assuming the precoding matrix reported by the victim 110 corresponding to the i^{th} PMI is

$${W}_{{P}_{i} \times \frac{Q}{N}}^{i} ,$$

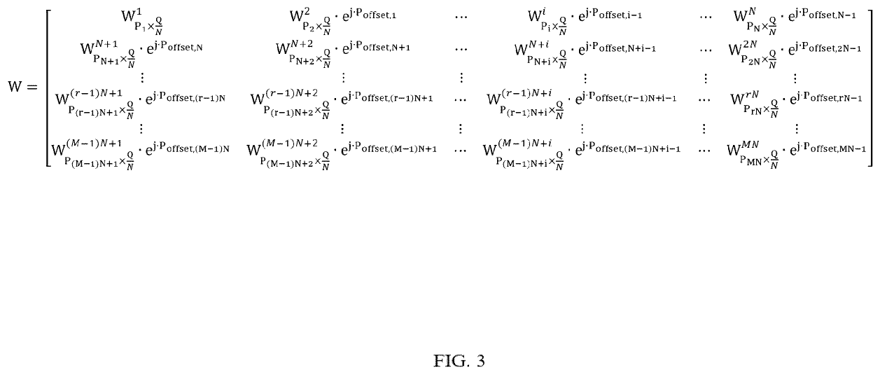

and the phase offset for the i^{th} PMI is P_{offset,i-1}, the combined precoding matrix may be as is shown in FIG. 3, where i is an integer and 1≤i≤N, and r is an integer and 1≤r≤M. P_{offset,1} is the phase offset corresponding to the second precoding matrix, P_{offset,2} is the phase offset corresponding to the third precoding matrix, and so forth. In this example,

$${W}_{{P}_{i} \times \frac{Q}{N}}^{i}$$

is a matrix with Pᵢ rows and Q/N columns.

For example, if the aggressor 108 is equipped with 64 Tx ports and victim 110 is equipped with 16 Rx ports, the aggressor 108 may transmit two RS resources to the victim 110. Each RS resource may be configured with 32 ports (for a total of 64 Tx ports). The victim 110 may report four PMIs and three phase offsets to the aggressor 108. The first PMI and the second PMI may be derived based on the first RS resource. The third PMI and fourth PMI may be derived based on the second RS resource. The combined precoding matrix in this example may then be:

$$W = [ \begin{matrix}{W}_{32 \times 8}^{1} & {W}_{32 \times 8}^{2} \cdot {e}^{j \cdot {P}_{offset , 1}} \\ {W}_{32 \times 8}^{3} \cdot {e}^{j \cdot {P}_{offset , 2}} & {W}_{32 \times 8}^{4} \cdot {e}^{j \cdot {P}_{offset , 3}}\end{matrix} ] .$$

In various embodiments, the phase offset report includes a plurality of phase offsets, and each phase offset is indicated by a phase offset sign (i.e., o) and a phase offset value (i.e., p). The phase offset sign may be indicated by one bit. For example, the value “0” may indicate a positive number (i.e., o=1) and the value “1” may indicate a negative number (i.e., o=−1), or vice versa. The phase offset value may be indicated by an index k,

$$p = \frac{k}{K} \cdot π ,$$

where K is an integer larger than 1, k is a nonnegative integer (e.g., k=0, 1, 2, . . . , K−1). The larger value of K, the higher resolution of phase offset. K may be configured by the high layer configuration or defined in the specification. If X bits are applied to indicate the phase offset value, then K may be equal to 2^{X}, where X is a nonnegative integer. For example, if X is equal to 8, then K is equal to 256, k=0, 1, 2, . . . , 255, and the resolution of phase offset value is π/256. Each phase offset is equal to its phase offset sign multiplied by its phase offset value, i.e., o·p.

In various embodiments, each PMI may correspond to one precoding matrix. The corresponding precoding matrix may be based on Type I codebook or Type II Codebook. For example, for Type I codebook, each PMI may include one codebook index for the corresponding precoding matrix table defined in the NR specification. In some other cases, each PMI may include codebook indexes i_{1,1}, i_{1,2}, and i_{1,3} defined in the NR specification. The aggressor 108 can determine the reported precoding matrix by the codebook index(es) and the number of Rx ports or rank indicator indicated by the victim 110. In another example for Type II codebook, in some other cases, each PMI may include codebook indexes i_{1,1}, i_{1,2}, i_{1,3,l}, i_{1,4,l}, i_{2,2,l} and i_{2,1,l} defined in the NR specification, wherein, i_{1,1} and i_{1,2} are DFT vectors, i_{1,3,l} is the strongest amplitude of layer L, i_{1,4,l} is a wideband amplitude coefficient of layer L, i_{2,2,l} is a subband amplitude coefficient of layer L, i_{2,1,l} is phase a coefficient of layer L, wherein L is larger than or equal to one. For example, if the Rank Indicator (RI) is 2, each PMI may include codebook indexes i_{1,1}, i_{1,2}, i_{1,3,1}, i_{1,4,1}, i_{1,3,2}, i_{1,4,2}, i_{2,2,1}, i_{2,1,2}, i_{2,2,1}, and i_{2,1,2} for each subband feedback report. The aggressor 108 can determine the reported precoding matrix by the codebook indexes and the number of Rx ports or rank indicator indicated by the victim 110.

In another embodiments, for Type II codebook, i_{1,1} and i_{1,2} can be modified to i_{1,1,L} and i_{1,2,L}, which means the DFT vector of layer L, wherein L is larger than or equal to 1 (one), due to the feedback accuracy requirement and rank limited of the current NR specification, it can further feedback the DFT vector of each layer, the combined precoding matrix by the aggressor 108 can be merged layer by layer, the phase offset between each layer may be further needed to feedback by victim 110 or no need. Even if M is equal to 1, the method can also be used.

The aggressor 108 may derive the channel state between the aggressor 108 and the victim 110 based on the PMI report, which includes more than one PMIs. Each PMI corresponds to one precoding matrix. For example, some example precoding matrixes may be as shown below in Table 1. The first column labelled “Codebook index” refers to the PMI, and the other columns refer to the corresponding precoding matrix. For example, if PMI is indicated as 0 and the number of Rx ports in the victim 110 is 2, then the corresponding precoding matrix for 2 layers transmission may be:

$$\frac{1}{2} [ \begin{matrix}1 & 1 \\ 1 & - 1\end{matrix} ] .$$

If PMI is indicated as 1, then the corresponding precoding matrix for 2 layers transmission may be

$$\frac{1}{2} [ \begin{matrix}1 & 1 \\ j & - j\end{matrix} ] .$$

However, the precoding matrixes are normalized matrixes. The values in each precoding matrix can be considered as a phase offset compared to the value in the first row and first column in the precoding matrix. Take

$$\frac{1}{2} [ \begin{matrix}1 & 1 \\ j & - j\end{matrix} ]$$

as an example, the value “1” in the first row and second column can be considered as 0 phase offset compared with the value “1” in the first row and first column of this matrix. The value “j” in the second row and first column can be considered as π/2 phase offset compared with the value “1” in the first row and first column of this matrix. Similarly, the value “−j” in the second row and second column can be considered as

$$- \frac{π}{2}$$

phase offset compared with the value “1” in the first row and first column of this matrix.

Because the aggressor 108 needs to combine more than one precoding matrixes to derive the combined precoding matrix, the phase offset between the individual precoding matrixes are needed. For example, if the aggressor 108 is equipped with four Tx ports and the victim 110 is equipped with two Rx ports, two CSI-RS resources with two ports may be configured for channel state measurement between the aggressor 108 and victim 110. In an example, assuming that victim 110 indicates the first PMI corresponding to the first CSI-RS resource as 0, and indicates the second PMI corresponding to the second CSI-RS resources as 1 according the precoding matrixes in table 1, without the phase offset between the first precoding matrix and the second precoding matrix, the aggressor 108 would derive the combined precoding matrix as

$$\frac{1}{2} [ \begin{matrix}1 & 1 \\ 1 & - 1 \\ 1 & 1 \\ j & - j\end{matrix} ] .$$

However, if the phase offset between the channel state corresponding to the second CSI-RS resource and the first CSI-RS resource is π/2, then the combined precoding matrix is

$$\frac{1}{2} [ \begin{matrix}1 & 1 \\ 1 & - 1 \\ 1 \times {e}^{j π} & 1 \times {e}^{j π} \\ j \times {e}^{j π} & - j \times {e}^{j π}\end{matrix} ] = \frac{1}{2} [ \begin{matrix}1 & 1 \\ 1 & - 1 \\ j & j \\ - 1 & 1\end{matrix} ] .$$

The aggressor 108 can derive the channel state between the aggressor 108 and victim 110 based on the reported precoding matrix from victim via some well-known algorithms, e.g., SVD (Singular Value Decomposition).

TABLE 1
Example of precoding matrixes

| Codebook | Number of layers^{υ} | |
|---|---|---|
| index | 1 | 2 |
| 0 | $\frac{1}{\sqrt{2}} [ \begin{matrix}1 \\ 1\end{matrix} ]$ | $\frac{1}{2} [ \begin{matrix}1 & 1 \\ 1 & - 1\end{matrix} ]$ |
| 1 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 2 | $\frac{1}{\sqrt{2}} [ \begin{matrix}1 \\ - 1\end{matrix} ]$ | — |
| 3 | $\frac{1}{\sqrt{2}} [ \begin{matrix}1 \\ - j\end{matrix} ]$ | — |

In various embodiments, different algorithms can be applied to derive the phase offset. Below, some algorithms are introduced. For example, assume that the aggressor 108 transmits a set of RS (Reference Signal) to the victim 110, where the set of RS includes M RS resources, and M is an integer larger than 1. Each RS resource among these M RS resources may be configured with Pᵢ RS ports, where i is an integer and 1≤i≤M, and Pᵢ is an integer and Pᵢ≥1. The victim 110 may be equipped with Q Rx ports or the victim 110 indicates rank number as Q to the aggressor 108. Based on each RS resource, the victim 110 can derive one channel matrix between the aggressor 108 and the victim 110. For the i^{th} RS resource of the M RS resources, the derived channel matrix between the aggressor 108 and the victim 110 based on the CSI-RS received by the victim is H_{P}_{ᵢ}_{×Q}ⁱ.

Using a first example algorithm, the victim 110 derives an i^{th} phase offset (i.e., P_{offset, i}) corresponding to the (i+1)^{th} precoding matrix compared with the first precoding matrix. The victim 110 derives the i^{th} phase offset as the phase offset between the value in the first row and first column of the (i+1)^{th} channel matrix and the value in the first row and first column of the first channel matrix, i.e., P_{offset,i}=tan⁻¹ H_{1×1}ⁱ⁺¹−tan⁻¹ H_{1×1}¹, where i is an integer and 1<i≤M. H_{1×1}¹ and H_{1×1}ⁱ⁺¹ are complex numbers, e.g.,

$$\frac{\sqrt{2} + \sqrt{2} j}{2} .$$

In this disclosure, tan⁻¹ is an operation to obtain the phase of a complex number in polar coordinates. Assuming X is a complex number, tan⁻¹X is an operation to obtain the phase of X in polar coordinates. For example, the phase of 1+0j,

$$\frac{\sqrt{2} + \sqrt{2} j}{2}$$

and j is 0, π/4 and π, respectively.

Using a second example algorithm, the victim 110 derives an i^{th} phase offset (i.e., P_{offset, i}) corresponding to the (i+1)^{th} precoding matrix compared with the first precoding matrix as the average offset between each value in the (i+1)^{th} channel matrix and the corresponding value in the first channel matrix. That is,

$${P}_{offset , i} = \frac{{\sum }_{m = 1 , n = 1}^{m = M , n = Q} {tan}^{- 1} {H}_{m \times n}^{i + 1} - {tan}^{- 1} {H}_{m \times n}^{1}}{M \cdot Q} ,$$

where i is an integer and 1<i≤M, and m and n are integer numbers.

For example, assuming the precoding matrix reported by the victim 110 corresponding to the i^{th} PMI is W_{P}_{ᵢ}_{×Q}ⁱ, and the phase offset for the i^{th} PMI is P_{offset,i-1}, the combined precoding matrix would be:

$$W = [ \begin{matrix}{W}_{{P}_{1} \times Q}^{1} \\ {W}_{{P}_{2} \times Q}^{2} \cdot {e}^{j \cdot {P}_{offset , 1}} \\ ⋮ \\ {W}_{{P}_{i} \times Q}^{i} \cdot {e}^{j \cdot {P}_{offset , i - 1}} \\ ⋮ \\ {W}_{{P}_{M} \times Q}^{M} \cdot {e}^{j \cdot {P}_{offset , M - 1}}\end{matrix} ] ,$$

where i is an integer and 1≤i≤M. P_{offset,1} is the phase offset corresponding to the second precoding matrix, P_{offset,2} is the phase offset corresponding to the third precoding matrix, and so forth.

In some embodiments, for a subband report, the victim 110 can provide a wideband phase offset and a subband phase offset relative to the wideband phase offset. For example, for the i^{th} PMI other than the first PMI, the wideband phase offset is P_{WBoffset,i-1} For the p^{th} subband, the subband phase offset is Δₚ. Then the combined precoding matrix for the p^{th} subband would be:

$$W = [ \begin{matrix}{W}_{{P}_{1} \times Q}^{1} \\ {W}_{{P}_{2} \times Q}^{2} \cdot {e}^{j \cdot ( {P}_{offset , 1} + {Δ}_{p} )} \\ ⋮ \\ {W}_{{P}_{i} \times Q}^{i} \cdot {e}^{j \cdot ( {P}_{offset , i - 1} + {Δ}_{p} )} \\ ⋮ \\ {W}_{{P}_{M} \times Q}^{M} \cdot {e}^{j \cdot ( {P}_{offset , M - 1} + {Δ}_{p} )}\end{matrix} ] ,$$

where i is an integer and 1≤i≤M, p is the subband index and p is an integer number, and j is the imaginary unit.

In some other embodiments, in addition to the M RS resources, the aggressor 108 may transmit another RS resource to the victim 110, where the RS resource is configured as M·S ports. S is an integer larger than 0. The i^{th} S ports for transmitting the RS resource are the same as the first S ports used for transmitting the i^{th} RS resources among the M RS resources, where i is an integer number and 1≤i≤M.

In some other embodiments, the phase offset report from the victim 110 includes another PMI, for example, a phase PMI. The aggressor 108 may derive the phase offset for the M PMIs based on the precoding matrix corresponding to this phase PMI. The phase offset for the second precoding matrix among the M precoding matrix is derived by the second S row of values and the first S row of values in the precoding matrix corresponding to this phase PMI, the phase offset for the third precoding matrix among the M precoding matrix is derived by the third S row of values and the first S row of values in the precoding matrix corresponding to this phase PMI, and so forth.

For example, if the aggressor 108 is equipped with four Tx ports and the victim 110 is equipped with two Rx ports, two 2 CSI-RS resources with two ports may be configured for channel state measurement between the aggressor 108 and the victim 110. Assuming that the victim 110 indicates the first PMI corresponding to the first CSI-RS resource as 0, and indicates the second PMI corresponding to the second CSI-RS resources as 1 according the precoding matrixes in table 1, above, without the phase offset between the first precoding matrix and the second precoding matrix, the aggressor 108 may derive the combined precoding matrix as

$$\frac{1}{2} [ \begin{matrix}1 & 1 \\ 1 & - 1 \\ 1 & 1 \\ j & - j\end{matrix} ] .$$

However, if the precoding matrix based on the phase PMI reported by the victim is

$$\frac{1}{\sqrt{2}} [ \begin{matrix}1 \\ j\end{matrix} ] ,$$

in this example, M is equal to 2, S is equal to 1, and the phase offset for the second precoding matrix among the two precoding matrixes is derived by the second row of value and the first row of value in the precoding matrix corresponding to this phase PMI, which is π/2 in this case. Then, after taking the phase offset into consideration, the combined precoding matrix may be:

$$\frac{1}{2} [ \begin{matrix}1 & 1 \\ 1 & - 1 \\ 1 \times {e}^{j π} & 1 \times {e}^{j π} \\ j \times {e}^{j π} & - j \times {e}^{j π}\end{matrix} ] = \frac{1}{2} [ \begin{matrix}1 & 1 \\ 1 & - 1 \\ j & j \\ - 1 & 1\end{matrix} ] .$$

To summarize the overall procedure for the new mechanism for channel measurement and interference measurement in accordance with various embodiments, an example is provided. In this example, the aggressor 108 is equipped with 64 Tx ports and the victim 110 is equipped with 16 Rx ports. The aggressor 108 and the victim 110 exchange configuration information related to the RS resources and the number of Tx/Rx ports.

In this example, the aggressor 108 transmits two RS resources (e.g., M=2) to the victim 110, where each RS resource is configured with 32 ports. The victim 110 measures the RS resources and derives the channel state between the aggressor 108 and the victim 110 corresponding to first RS resource and the second RS resource as H1_{32×16} and H2_{32×16}, respectively. The victim 110 derives the precoding matrixes for H1_{32×16} as W1_{32×8} and W2_{32×8}. Similarly, the victim 110 derives the precoding matrixes for H2_{32×16} as W3_{32×8} and W4_{32×8}. (In this example, N=2, so the PMI report includes 4=2·2 PMIs). Based on the channel state H1_{32×16} and H2_{32×16}, the victim 110 derives the phase offsets for W2_{32×8}, W3_{32×8} and W4_{32×8} compared with W1_{32×8} as P_{offset,1}, P_{offset,2} and P_{offset,3}, respectively. The victim 110 then indicates the PMI report and phase offset report to the aggressor 108, where the PMI report indicates the corresponding precoding matrixes and the phase offset report indicates the corresponding phase offsets.

The aggressor 108 receives the PMI report and phase offset report. The aggressor 108 then derives the precoding matrixes W1_{32×8}, W2_{32×8}, W3_{32×8}, and W4_{32×8}, and derives the phase offsets P_{offset,1}, P_{offset,2}, and P_{offset,3}. The aggressor 108 the derives the combined precoding matrix as:

$${w}_{64 \times 16} = [ \begin{matrix}{W}_{32 \times 8}^{1} & {W}_{32 \times 8}^{2} \cdot {e}^{j \cdot {P}_{offset , 1}} \\ {W}_{32 \times 8}^{3} \cdot {e}^{j \cdot {P}_{offset , 2}} & {W}_{32 \times 8}^{4} \cdot {e}^{j \cdot {P}_{offset , 3}}\end{matrix} ] .$$

In this example, the aggressor 108 can also derive the channel state between the aggressor 108 and the victim 110 as H_{64×16} depending on the specific algorithms used. Lastly, the aggressor 108 can perform cross link interference (CLI) handling to address the CLI between the aggressor 108 and the victim 110 based on the combined precoding matrix or the combined channel state, e.g., beam null.

So configured, the new mechanisms for channel measurement and interference measurement can accommodate different numbers of antenna ports. By allowing for multiple precoding matrixes, greater flexibility is provided for channel and interference measurement, for example, by allowing for more than 32 ports.

### Association Between Reference Signals (RS)

The aggressor 108 may transmit RS to the victim 110 for channel measurement. The victim 110 measures the channel state between the aggressor 108 and the victim 110 based on the RS, and the victim 110 can also identify the aggressor 108 based on the RS. The channel state reflects the fast fading of the channel well. However, in order to address the Cross Link Interference (CLI) between the aggressor 108 and the victim 110, the aggressor 108 and the victim 110 also need to know the CLI strength via Received Signal Strength Indicator (RSSI), for example. Both of the channel state and CLI strength are important for the CLI handling between the aggressor 108 and the victim 110. In one example implementation, the channel state information and CLI strength are used to finetune the detailed algorithm design and select the appropriate CLI algorithm, respectively.

In accordance with the present embodiment, the RS for channel measurement and CLI measurement resource are associated. As such, the victim 110 can measure the RS first and identify the aggressor(s) first, and then only measure the CLI measurement resources that are associated with the RS corresponding the identified aggressor(s). In this instance, the measurement efficiency for the victim 110 is increased and both of the channel state and the CLI strength can be obtained by the victim 110.

In accordance with various embodiments, a method performed by the aggressor wireless device 108, or by the victim wireless device 110, for channel and interference measurement is disclosed. As part of this method, the aggressor wireless device 108 indicates to the victim wireless device 110, and the victim wireless device 110 received from the aggressor wireless device 108, an RS configuration and a CLI measurement resource configuration. The RS configuration configures at least one RS, wherein each RS of the at least one RS includes an aggressor ID of the aggressor wireless device. Also, the CLI measurement resource configuration associates each one of the at least one RS with M CLI measurement resources, wherein M is an integer greater than 0. The method also includes the aggressor 108 transmitting to the victim 110, and the victim 110 receiving from the aggressor 108, the at least one RS according to the RS configuration.

In various embodiments, the aggressor ID includes at least one of the base station ID or the UE ID, the Cell ID or carrier ID, where the aggressor 108 transmits the RS on this Cell or carrier, and/or a sequence configured for each gNB by the OAM (Operations, Administration and Maintenance).

In accordance with this embodiment, the victim 110 receives the RS. The victim 110 then measures the M CLI measurement resources associated with the at least one RS to generate measurement results of the at least one RS or the M CLI measurement resources associated with the at least one RS. The victim 110 then indicates or transmits the measurement results 114 to the aggressor 108, and the aggressor 108 receives the measurement results 114. The victim 110 can derive the aggressor ID and measure the channel state between the aggressor 108 and the victim 110 based on the RS received by the victim 110.

In various embodiments, the measurement result includes at least one of the following:
1. The aggressor ID of the aggressor 108.
2. The CSI (Channel State Information) report based on the at least one RS, e.g., RI (Rank indicator), PMI (Precoding Matrix Indicator), resource indicator and etc.
3. The CLI strength report based on the CLI measurement resources. The CLI strength report may include at least one of the following:
   a) A Received Signal Strength Indicator (RSSI) for each of the M CLI measurement resources.
   b) An average RSSI among all the M CLI measurements.
   c) N CLI measurement resource indicators, wherein N is an integer greater than 0, and where the maximum N RSSI values are measured in the CLI measurement resources corresponding to the CLI measurement resource indicators. In certain examples, N can be set as 2 or 4.
   d) N CLI measurement resource indicators, wherein N is an integer greater than 0, where the minimum N RSSI values are measured in the CLI measurement resources corresponding to the CLI measurement resource indicators. In certain examples, N can be set as 2 or 4.
   e) N CLI measurement resource indicators and corresponding RSSI, wherein N is an integer greater than 0, and wherein the N CLI measurement resource indicators correspond to N CLI measurement resources in which the maximum or minimum N RSSI values are measured.

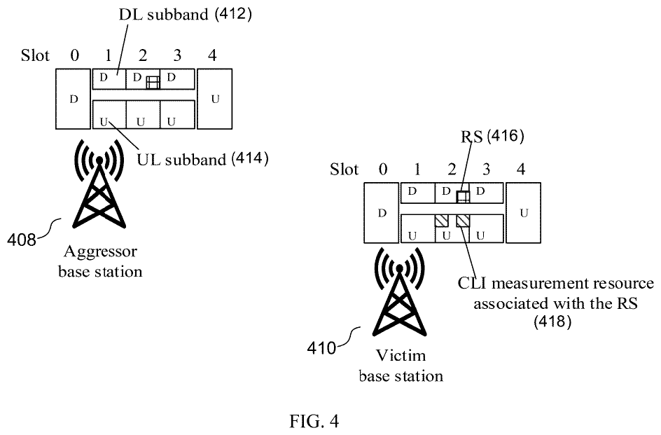

Referring to FIG. 4, an example is illustrated involving an aggressor base station 408 and a victim base station 410. Although this example illustrates the aggressor and victim as both being base stations, either or both of the aggressor or victim may be UEs in different examples. In this example, the aggressor base station 408 and the victim base station 410 apply the same slot formation configuration and subband pattern. In this example, in slot 0, all the frequency resources are used for DL transmission. In slot 4, all the frequency resources are used for UL transmission. In slots 1, 2, and 3, the higher part of the frequency resources is used for DL transmission, which is also known as DL subband 412, and the lower part of frequency resources is used for UL transmission, which is also known as UL subband 414. Due to the limited gap between DL subband 412 and UL subband 414 in the frequency domain, the DL transmission transmitted by the aggressor base station 408 may interfere with the UL reception in the UL subband 414 of the victim base station 410. In other words, the DL transmission transmitted by the aggressor base station 408 may cause Cross Link Interference (CLI) with the UL reception in the UL subband 414 of the victim base station 410.

In this example, the aggressor base station 408 configures one RS 416 in the DL subband 412 and transmits the RS 416 to the victim base station 410. The victim base station 410 receives this RS 416. The victim base station 410 identifies the ID carried by the RS 416 and measures the CSI between these two base stations.

In this example, two CLI measurement resources 418 are associated with the RS 416. The aggressor base station 408 can transmit the DL transmission with different beams or different powers in the same symbols as the CLI measurement resource. In this case, the CLI measurement result for the different CLI measurement resources corresponds to different beam or power applied by the aggressor base station 408. Once the aggressor base station 408 receives the CLI measurement result for different CLI measurement resources, the aggressor base station 408 can determine the appropriate DL transmission beam and power to address the CLI.

The victim may need to perform UL reception in the RS resources even if the victim 410 is configured as DL in the corresponding resources. In this example, the victim base station 410 may need to change from DL transmission to UL reception. Thus, a transition gap is needed for the victim 410 to perform DL/UL transition. If different aggressors transmit different RSs in different symbols, then the victim 410 needs multiple transition gaps in order to perform RS measurement for different aggressors. To address this issue, in accordance with various embodiments, the RS may apply a comb-like pattern in the frequency domain. In this case, the RS for different aggressors can be transmitted in the same symbol.

In certain examples, the RS applies a comb like pattern in the frequency domain. The RS configuration may indicate at least one of the following:
1. The occupied RBs (Resource Blocks) by the at least one RS;
2. The occupied symbols by the at least one RS;
3. A periodicity and starting slot within the periodicity in time domain of occupied Resource Elements (RE) by the at least one RS;
4. A transmission comb number, which indicates the gap between two Resource Elements (REs) occupied by the RS in frequency domain. For example, if a transmission comb number is indicated as 2, the REs occupied by the RS may be REs with odd indexes or even indexes.
5. A transmission comb offset, which indicates the offset for the REs occupied by the at least one RS. For example, if a transmission comb number is indicated as 2, and if the transmission comb offset is indicated as 0, then REs occupied by the RS may be REs with even indexes. Similarly, if the transmission comb offset is indicated as 1, then REs occupied by the RS may be REs with odd indexes.

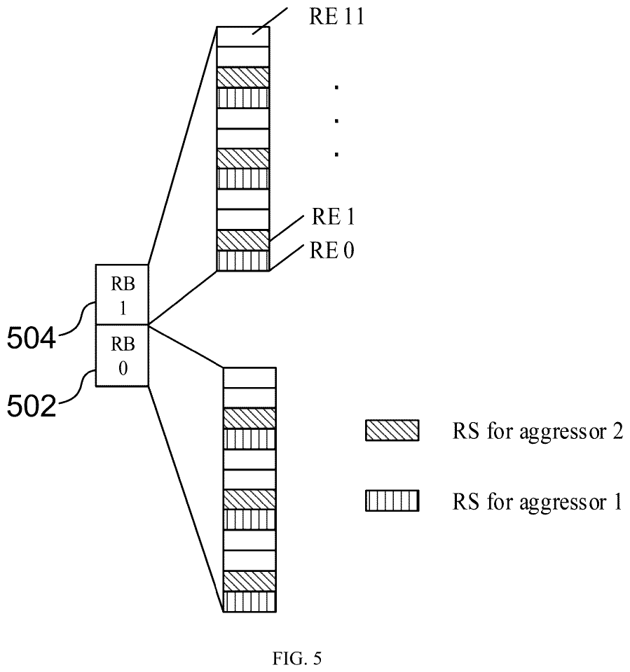

Referring to FIG. 5, an example of the comb-like pattern is illustrated. Two Resource Blocks (RB 0 502 and RB 1 504) are illustrated. In this example, a transmission comb number and transmission comb offset for the RS for a first aggressor 1 are 4 and 0, respectively. The transmission comb number and transmission comb offset for the RS for a second aggressor 2 are 4 and 1, respectively. The occupied RBs for the RS for aggressor 1 and aggressor 2 are both RB 0 502 and RB 1 504. Thus, in this example, the RS for the first aggressor 1 occupies the RE 0, RE 4, and RE 8 in each of the RB 0 502 and RB 1 504. The RS for aggressor 2 occupies the RE 1, RE 5, and RE 9 in the RB 0 502 and RB 1504.

In certain approaches, the aggressor 108 can transmit the RS 416 in the DL subband 412. Then the victim 110 has to receive the RS in the DL subband 412. As such, a transition gap may be needed for the victim 110 to perform DL/UL transition. After finishing the DL transmission in the DL subband, the victim 110 also may need a transition gap to perform DL/UL transition. In this case, aggressor 108 can transmit the RS in the last L symbols of the DL subband 412 to share the same transition gap.

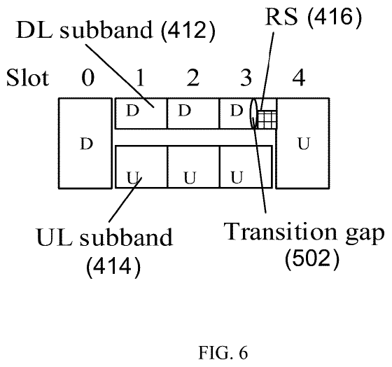

Referring to FIG. 6 as an example, the RS 416 is transmitted in the last few symbols of the DL subband 412 prior to the UL slot. In this case, only one transition gap 502 is needed before the RS 416. The victim 110 converts from DL transmission to UL reception with the gap 502 before the RS 416 and performs UL reception in the next UL slot without any gap.

Similarly, the aggressor 108 can transmit the RS 416 in the UL subband 414. Then the victim 110 receives the RS 416 in the UL subband 414. As such, a transition gap may be needed for the aggressor 108 to perform DL/UL transition since the aggressor 108 needs to transmit the RS 416 in the UL subband 414. To reduce the number of transition gaps, the aggressor 108 can transmit the RS 416 in the first L symbols in the UL subband 414. In this case, only one transition gap is needed for the aggressor 108 to convert from DL slot to UL subband reception and from DL transmission in the UL subband 414 to UL subband reception.

In various embodiments, each CLI measurement resource may be associated with P UL muting resources, where P is an integer larger than 0. Within each UL muting resource, no uplink transmission is transmitted. Referring back to FIG. 4 as an example, the victim (e.g., victim base station 410) performs CLI measurement on the CLI measurement resource 418. An UL muting resource can be configured the same as the CLI measurement resource, where each CLI measurement resource may be associated with one UL muting resource. In this case, the UE will not transmit uplink transmission in this UL muting resource, otherwise the uplink transmission transmitted by the UE will impact the CLI measurement performed by the victim. Each UL muting resource may be configured to different UEs attached with different base stations.

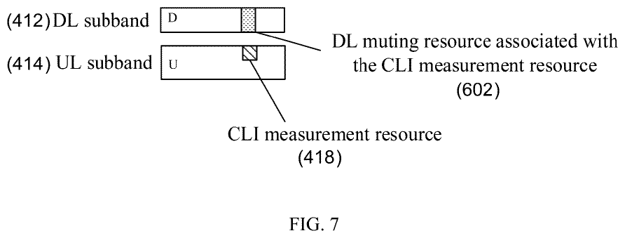

In another approach, each CLI measurement resource may be associated with Q DL muting resources, where Q is an integer larger than 0. Within each DL muting resource, no downlink transmission is transmitted. Each DL muting resource may be configured to different base stations. Referring to FIG. 7, as an example, one CLI measurement resource 418 is configured in the UL subband 414. One DL muting resource 602 associated with the CLI measurement resource 418 is configured in the DL subband 412 and it covers the same symbols as the CLI measurement resource 414. The DL muting resource 602 can occupy more symbols, but it should cover the symbols occupied by the CLI measurement resource 418. In this case, since no DL transmission is transmitted in the DL muting resource, the self-interference can be avoided when the victim 110 performs CLI measurement in the CLI measurement resource.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation/example/approach” as used herein does not necessarily refer to the same embodiment and the phrase “in another embodiment/implementation/example/approach” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method performed by an aggressor wireless device for channel and interference measurement comprising:
transmitting a set of Reference Signals (RS) to a victim wireless device,
wherein the set of RS comprises M RS resources, wherein M is an integer larger than 1, and
wherein an i^{th} individual RS resource of the M RS resources includes Pᵢ RS ports, wherein i is an integer and 1≤i≤M, and wherein Pᵢ is an integer and Pᵢ≥1; and
receiving, from the victim wireless device, a measurement report regarding the set of RS, the measurement report comprising a Precoding Matrix Indicator (PMI) report and a phase offset report.

2. The method according to claim 1, further comprising:
deriving, by the aggressor wireless device, a combined precoding matrix using the PMI report and the phase offset report.

3. The method according to claim 1, wherein
M groups of RS resources are configured to the victim wireless device, where each group contains Kᵢ RS resources, wherein Kᵢ is an integer greater than 1, and wherein an i^{th} RS resource is from an i^{th} group of the M groups of RS resources.

4. The method according to claim 1, wherein
the PMI report comprises M PMIs each corresponding to one of the M RS resources, and
wherein each PMI of the M PMIs corresponds to one precoding matrix.

5. The method according to claim 1, wherein
the phase offset report comprises M−1 phase offsets, and
wherein an m^{th} phase offset is a phase offset of an (m+1)^{th} precoding matrix compared with a first precoding matrix, where m is an integer and 1≤m≤M−1.

6. The method according to one of claims 4-5, wherein:
the measurement report is a subband report,
the M PMIs are for each subband, and
the M−1 phase offsets are for each subband.

7. The method according to claim 1, wherein:
the PMI report comprises X PMIs corresponding to the M RS resources,
wherein X=M·N, wherein N is an integer larger than 0,
wherein a first set of N PMIs of the X PMIs correspond to a first RS resource of the M RS resources,
wherein an M^{th} set of N PMIs of the X PMIs correspond to an M^{th} RS resource of the M RS resources, and
wherein each PMI of the X PMIs corresponds to one precoding matrix.

8. The method according to claim 7, wherein:
the phase offset report comprises X−1 phase offsets, and
wherein an m^{th} phase offset is a phase offset of an (m+1)^{th} precoding matrix compared with a first precoding matrix, where m is an integer and 1≤m≤X−1.

9. The method according to one of claims 7-8, wherein:
the measurement report is a subband report,
the X PMIs are for each subband, and
the X−1 phase offsets are for each subband.

10. The method according to claim 1, wherein:
the phase offset report comprises a plurality of phase offsets, and
each phase offset of the plurality of phase offsets is indicated by a phase offset sign (o) and a phase offset value (p).

11. The method according to claim 10, wherein:
the phase offset sign (o) is indicated by one bit.

12. The method according to claim 10, wherein:
the phase offset value (p) is indicated by an index k, wherein
$$p = \frac{k}{k} \cdot π ,$$
where K is an integer number larger than 1, and k is nonnegative integer number between 0 and K−1.

13. The method according to claims 1-12, further comprising:
deriving a channel state matrix between the aggressor wireless device and the victim wireless device, wherein for an i^{th} RS resource of the M RS resources, the derived channel state matrix is H_{P}_{_{i×Q}}ⁱ, where Q is at least one of a number of RX ports of the victim wireless device or a rank number.

14. The method according to claim 13, wherein:
the phase offset report comprises a plurality of phase offsets,
an i^{th} phase offset (P_{offset, i}) of the plurality of phase offsets corresponding to an (i+1)^{th} precoding matrix compared with a first precoding matrix is derived as a phase offset between a value in the first row and first column of the (i+1)^{th} channel matrix and a value in a first row and first column of the first channel matrix

15. The method according to claim 14, wherein:
deriving the phase offset is performed using the following equation:
$${P}_{offset , i} = {tan}^{- 1} {H}_{1 \times 1}^{i + 1} - {tan}^{- 1} {H}_{1 \times 1}^{1} .$$

16. The method according to claim 13, wherein:
the phase offset report comprises a plurality of phase offsets,
an i^{th} phase offset (P_{offset, i}) of the plurality of phase offsets corresponding to an (i+1)^{th} precoding matrix compared with a first precoding matrix is derived as an average offset between each value in the (i+1)^{th} channel matrix and a corresponding value of the first channel matrix.

17. The method according to claim 16, wherein:
deriving the phase offset is performed using the following equation:
$${P}_{offset , i} = \frac{{\sum }_{m = 1 , n = 1}^{m = M , n = Q} {tan}^{- 1} {H}_{m \times n}^{i + 1} - {tan}^{- 1} {H}_{m \times n}^{1}}{M \cdot Q} ,$$
where m and n are integer numbers.

18. The method according to any of claims 1-17, wherein the aggressor wireless device and the victim wireless device comprise at least one of the following combinations:
the aggressor wireless device and the victim wireless device are both wireless access network nodes;
the aggressor wireless device and the victim wireless device are both wireless terminal devices;
the aggressor wireless device is a wireless access network node and the victim wireless device is a wireless terminal device; or
the aggressor wireless device is a wireless terminal device and the victim wireless device is a wireless access network node.

19. The method according to any of claims 1-18, wherein each RS resource of the M RS resources is configured with a same number of RS ports.

20. The method according to any of claims 1-19, further comprising:
transmitting the M RS resources in a same slot or in consecutive slots.

21. A method performed by a victim wireless device for channel and interference measurement comprising:
receiving a set of Reference Signals (RS) from an aggressor wireless device,
wherein the set of RS comprises M RS resources, wherein M is an integer larger than 1, and
wherein an i^{th} individual RS resource of the M RS resources includes Pᵢ RS ports, wherein i is an integer and 1≤i≤M, and wherein Pᵢ is an integer and Pᵢ≥1;
generating a measurement report regarding the set of RS, the measurement report comprising a Precoding Matrix Indicator (PMI) report and a phase offset report; and
transmitting the measurement report to the aggressor wireless device.

22. The method according to claim 21, wherein
the PMI report and the phase offset report are used by the aggressor wireless device to derive a combined precoding matrix.

23. The method according to claim 21, wherein:
M groups of RS resources are configured to the victim wireless device, where each group contains Kᵢ RS resources, wherein Kᵢ is an integer greater than 1, and wherein an i^{th} RS resource is from an i^{th} group of the M groups of RS resources.

24. The method according to claim 21, further comprising,
generating the PMI report to include M PMIs each corresponding to one of the M RS resources,
wherein each PMI of the M PMIs corresponds to one precoding matrix.

25. The method according to claim 21, further comprising:
generating the phase offset report to include M−1 phase offsets; and
measuring an m^{th} phase offset as a phase offset of an (m+1)^{th} precoding matrix compared with a first precoding matrix, where m is an integer and 1≤m≤M−1.

26. The method according to one of claims 24-25, wherein:
the measurement report is a subband report,
the M PMIs are for each subband, and
the M−1 phase offsets are for each subband.

27. The method according to claim 21, further comprising:
generating the PMI report to include X PMIs corresponding to the M RS resources,
wherein X=M·N, wherein N is an integer larger than 0,
wherein a first set of N PMIs of the X PMIs correspond to a first RS resource of the M RS resources,
wherein an M^{th} set of N PMIs of the X PMIs correspond to an M^{th} RS resource of the M RS resources, and
wherein each PMI of the X PMIs corresponds to one precoding matrix.

28. The method according to claim 27, further comprising:
generating the phase offset report to include X−1 phase offsets,
measuring an m^{th} phase offset as a phase offset of an (m+1)^{th} precoding matrix compared with a first precoding matrix, where m is an integer and 1≤m≤X−1.

29. The method according to one of claims 27-28, wherein:
the measurement report is a subband report,
the X PMIs are for each subband, and
the X−1 phase offsets are for each subband.

30. The method according to claim 21, wherein:
the phase offset report comprises a plurality of phase offsets, and
each phase offset of the plurality of phase offsets is indicated by a phase offset sign (o) and a phase offset value (p).

31. The method according to claim 30, wherein:
the phase offset sign (o) is indicated by one bit.

32. The method according to claim 30, wherein:
the phase offset value (p) is indicated by an index k, wherein
$$p = \frac{k}{k} \cdot π ,$$
where K is an integer number larger than 1, and k is nonnegative integer number between 0 and K−1.

33. The method according to claims 21-32, further comprising:
deriving a channel state matrix between the aggressor wireless device and the victim wireless device, wherein for an i^{th} RS resource of the M RS resources, the derived channel state matrix is H_{P}_{ᵢ}_{×Q}ⁱ, where Q is at least one of a number of RX ports of the victim wireless device or a rank number.

34. The method according to claim 33, further comprising:
deriving an i^{th} phase offset (P_{offset, i}) of a plurality of phase offsets of the phase offset report corresponding to an (i+1)^{th} precoding matrix compared with a first precoding matrix, wherein the i^{th} phase offset is derived as a phase offset between a value in the first row and first column of the (i+1)^{th} channel matrix and a value in a first row and first column of the first channel matrix

35. The method according to claim 34, further comprising:
deriving the phase offset using the following equation:
$${P}_{offset , i} = {tan}^{- 1} {H}_{1 \times 1}^{i + 1} - {tan}^{- 1} {H}_{1 \times 1}^{1} .$$

36. The method according to claim 33, further comprising:
deriving an i^{th} phase offset (P_{offset, i}) of a plurality of phase offsets of the phase offset report corresponding to an (i+1) precoding matrix compared with a first precoding matrix, wherein the i^{th} phase offset is derived as an average offset between each value in the (i+1)^{th} channel matrix and a corresponding value of the first channel matrix.

37. The method according to claim 36, further comprising:
deriving the phase offset using the following equation:
$${P}_{offset , i} = \frac{{\sum }_{m = 1 , n = 1}^{m = M , n = Q} {tan}^{- 1} {H}_{m \times n}^{i + 1} - {tan}^{- 1} {H}_{m \times n}^{1}}{M \cdot Q} ,$$
where m and n are integer numbers.

38. The method according to any of claims 21-37, wherein the aggressor wireless device and the victim wireless device comprise at least one of the following combinations:
the aggressor wireless device and the victim wireless device are both wireless access network nodes;
the aggressor wireless device and the victim wireless device are both wireless terminal devices;
the aggressor wireless device is a wireless access network node and the victim wireless device is a wireless terminal device; or
the aggressor wireless device is a wireless terminal device and the victim wireless device is a wireless access network node.

39. The method according to any of claims 21-38, wherein each RS resource of the M RS resources is configured with a same number of RS ports.

40. The method according to any of claims 21-39, further comprising:
receiving the M RS resources in a same slot or in consecutive slots.

41. A method performed by an aggressor wireless device for channel and interference measurement comprising:
indicating, to a victim wireless device, a Reference Signals (RS) configuration and a Cross Link Interference (CLI) measurement resource configuration,
wherein the RS configuration configures at least one RS,
wherein each RS of the at least one RS includes an aggressor ID of the aggressor wireless device, and
wherein the CLI measurement resource configuration associates each one of the at least one RS with M CLI measurement resources, wherein M is an integer greater than 0; and
transmitting the at least one RS to the victim wireless device according to the RS configuration.

42. The method according to claim 41, further comprising:
receiving measurement results from the victim wireless device, wherein the measurement results comprise results regarding measurement by the victim wireless device of the at least one RS or the M CLI measurement resources associated with the at least one RS.

43. The method according to claim 42, wherein the measurement results comprise at least one of the following:
the aggressor ID of the aggressor wireless device;
a Channel State Information (CSI) report based on the at least one RS; or
a CLI strength report based on the M CLI measurement resources.

44. The method according to claim 43, wherein the CLI strength report further comprises at least one of the following:
a Received Signal Strength Indicator (RSSI) for each of the M CLI measurement resources;
an average RSSI among all the M CLI measurement resources;
N CLI measurement resource indicators, wherein N is an integer greater than 0, and where the maximum N RSSI values are measured in the CLI measurement resources corresponding to the CLI measurement resource indicators;
N CLI measurement resource indicators, wherein N is an integer greater than 0, where the minimum N RSSI values are measured in the CLI measurement resources corresponding to the CLI measurement resource indicators; or
N CLI measurement resource indicators and corresponding RSSI, wherein N is an integer greater than 0, and wherein the N CLI measurement resource indicators correspond to N CLI measurement resources in which the maximum or minimum N RSSI values are measured.

45. The method according to claim 41, wherein
the RS configuration indicates at least one of the following:
occupied Resource Blocks (RBs) by the at least one RS;
occupied symbols by the at least one RS;
a periodicity and starting slot within the periodicity in time domain of occupied Resource Elements (RE) by the at least one RS;
a transmission comb number indicating a gap between two REs occupied by the at least one RS in frequency domain; or
a transmission comb offset indicating an offset for the REs occupied by the at least one RS.

46. The method according to claim 41, comprising:
transmitting the at least one RS in a last L symbols of a DL subband.

47. The method according to claim 41, comprising:
transmitting the at least one RS in a first L symbols of an UL subband.

48. The method according to claim 41, wherein:
each CLI measurement resource is associated with P UL muting resources, where P is an integer larger than 0, wherein no uplink transmission is transmitted within each UL muting resource.

49. The method according to claim 41, wherein:
each CLI measurement resource is associated with Q DL muting resources, where Q is an integer larger than 0, wherein no downlink transmission is transmitted within each DL muting resource.

50. A method performed by a victim wireless device for channel and interference measurement comprising:
receiving an indication from an aggressor wireless device of a Reference Signals (RS) configuration and a Cross Link Interference (CLI) measurement resource configuration,
wherein the RS configuration configures at least one RS,
wherein each RS of the at least one RS includes an aggressor ID of the aggressor wireless device, and
wherein the CLI measurement resource configuration associates each one of the at least one RS with M CLI measurement resources, wherein M is an integer greater than 0; and
receiving the at least one RS from the aggressor wireless device according to the RS configuration.

51. The method according to claim 50, further comprising:
measuring the M CLI measurement resources associated with the at least one RS to generate measurement results of the at least one RS or the M CLI measurement resources associated with the at least one RS; and
transmitting the measurement results to the aggressor wireless device.

52. The method according to claim 51, wherein the measurement results comprise at least one of the following:
the aggressor ID of the aggressor wireless device;
a Channel State Information (CSI) report based on the at least one RS; or
a CLI strength report based on the M CLI measurement resources.

53. The method according to claim 52, wherein the CLI strength report further comprises at least one of the following:
a Received Signal Strength Indicator (RSSI) for each of the M CLI measurement resources;
an average RSSI among all the M CLI measurement resources;
N CLI measurement resource indicators, wherein N is an integer greater than 0, and where the maximum N RSSI values are measured in the CLI measurement resources corresponding to the CLI measurement resource indicators;
N CLI measurement resource indicators, wherein N is an integer greater than 0, where the minimum N RSSI values are measured in the CLI measurement resources corresponding to the CLI measurement resource indicators; or
N CLI measurement resource indicators and corresponding RSSI, wherein N is an integer greater than 0, and wherein the N CLI measurement resource indicators correspond to N CLI measurement resources in which the maximum or minimum N RSSI values are measured.

54. The method according to claim 50, wherein
the RS configuration indicates at least one of the following:
occupied Resource Blocks (RBs) by the at least one RS;
occupied symbols by the at least one RS;
a periodicity and starting slot within the periodicity in time domain of occupied Resource Elements (RE) by the at least one RS;
a transmission comb number indicating a gap between two REs occupied by the at least one RS in frequency domain; or
a transmission comb offset indicating an offset for the REs occupied by the at least one RS.

55. The method according to claim 50, comprising:
receiving the at least one RS in a last L symbols of a DL subband.

56. The method according to claim 50, comprising:
receiving the at least one RS in a first L symbols of an UL subband.

57. The method according to claim 50, wherein:
each CLI measurement resource is associated with P UL muting resources, where P is an integer larger than 0, wherein no uplink transmission is transmitted within each UL muting resource.

58. The method according to claim 50, wherein:
each CLI measurement resource is associated with Q DL muting resources, where Q is an integer larger than 0, wherein no downlink transmission is transmitted within each DL muting resource.

59. An apparatus for wireless communication comprising a processor that is configured to carry out the method of any of claims 1 to 58.

60. A non-transitory computer readable medium having code stored thereon, the code when executed by a processor, causing the processor to implement the method recited in any of claims 1 to 58.
